(19) United States
(12) Patent Application Publication
(10) Pub. No.: US 2019/0377801 A1
(43) Pub. Date: Dec. 12, 2019

(54) RELATIONAL DATA MODEL FOR HIERARCHICAL DATABASES

(71) Applicant: Deloitte Development LLC, Hermitage, TN (US)

(72) Inventors: Florian McKee, Austin, TX (US); Stefan Aulbach, Dietenheim (DE)

(21) Appl. No.: 16/005,100

(22) Filed: Jun. 11, 2018

(51) Int. Cl. G06F 17/30

(52) U.S. Cl. CPC G06F 17/303; G06F 17/30604; G06F 17/30327

(57) ABSTRACT

Methods, systems, and apparatus, including computer programs encoded on a computer storage medium, for storing data from a hierarchical structure with labels that encode the data's respective position within a data structure that maps hierarchically structured information into relationally structured data. The data structure includes physical nodes, where each physical node represents a data node of the hierarchical structure, and virtual nodes, where each virtual node represents a type of hierarchical relationship between corresponding physical nodes. Each virtual node serves as an expansion node that permits addition and deletion of data within the hierarchical structure without altering labels associated with existing data.

### TECHNICAL FIELD

The present disclosure relates to hierarchical and relational databases.

### BACKGROUND

Hierarchical database systems and relational database management systems (RDBMSs) are used to manage vast quantities of data. There is much interest in the migration of data from a hierarchical to a relational database system. However, the inherent mismatch between the hierarchical and relational data models makes such a migration challenging. Furthermore, in many hierarchical systems (e.g., IBM's Information Management System (IMS)), there is a need to conduct data migration operations in a processor-efficient manner, while providing high performance queries, and navigation across hierarchical data.

Because relational data models do not provide adequate transitive dependencies between data entries, mismatches often occur between hierarchical and relational databases when attempting to migrate data. A solution that is inherently portable is needed to permit data migration to arbitrary RDBMSs. However, present solutions either trade query performance against the costs for data migration, or lack portability due to reliance on vendor-specific extensions.

### SUMMARY

Implementations of the present disclosure include methods for improving the efficiency of database migrations between hierarchical and relational database systems. In some implementations, actions include storing data from a hierarchical structure with labels that encode the data's respective position within a data structure that maps hierarchically structured information into relationally structured data. The data structure includes physical nodes, where each physical node represents a data node of the hierarchical structure, and virtual nodes, where each virtual node represents a type of hierarchical relationship between corresponding physical nodes. Each virtual node serves as an expansion node that permits addition and deletion of data within the hierarchical structure without altering labels associated with existing data.

Other implementations include corresponding systems, apparatus, and computer programs, configured to perform the actions of the methods, encoded on computer storage devices. These and other implementations can each optionally include one or more of the following features.

Some implementations include inserting a new data node into the hierarchical structure by: identifying a virtual node that represents a location in the hierarchical structure in which the new data node is to be inserted, generating a new physical node to represent the new data node, the new physical node linked to the identified virtual node within the data structure, and generating a label for the new data node based, in part, on a type of the virtual node.

In some implementations, a label for each node of the data structure encodes a path from a root node to the node's position within the data structure by representing each physical node along the path by an integer value and by representing each virtual node along the path by a coded value indicative of a type of each respective virtual node.

In some implementations, identities of successive nodes along the path are concatenated together to provide the label.

In some implementations, virtual node identities are represented by 2-bit codes that indicate the type of a respective virtual node. In some implementations, physical node identities are represented by integer values ranging from 0 to 2^{k}−1, where k is a positive integer. In some implementations, a first value of k for physical nodes in a first portion of the data structure is different from a second value of k for physical nodes in a second portion of the data structure. Some implementations include determining a value of k for a certain physical node based on scanning components of a label of the certain physical node.

In some implementations, identifying the virtual node includes identifying a leftmost sibling node of the new data node, and determining that the leftmost sibling node is not located in a leftmost physical node position. In such implementations, generating the new physical node to represent the new data node includes assigning the new data node to a new physical node position that is left of the leftmost sibling node.

In some implementations, identifying the virtual node includes identifying a leftmost sibling node of the new data node, and determining that the leftmost sibling node is located in a leftmost physical node position. In such implementations, generating the new physical node to represent the new data node includes generating a new virtual node sub-tree, and assigning the new data node as a first physical node descendant of the new virtual node sub-tree.

In some implementations, a type of a virtual node of the new virtual node sub-tree indicates a leftward expansion of the data structure.

In some implementations, identifying the virtual node includes identifying a rightmost sibling node of the new data node, and determining that the rightmost sibling node is not located in a rightmost physical node position. In such implementations, generating the new physical node to represent the new data node includes assigning the new data node to a new physical node position that is right of the rightmost sibling node.

In some implementations, identifying the virtual node includes identifying a rightmost sibling node of the new data node, and determining that the rightmost sibling node is located in a rightmost physical node position. In such implementations, generating the new physical node to represent the new data node includes generating a new virtual node sub-tree, and assigning the new data node as a first physical node descendant of the new virtual node sub-tree.

In some implementations, a type of a virtual node of the new virtual node sub-tree indicates a rightward expansion of the data structure.

In some implementations, identifying the virtual node includes identifying two existing nodes to insert the new data node between, and determining, based on the labels of the two existing nodes, that the new data node can be inserted in either a position that is right or a position that is left of one of the two existing nodes. In such implementations, generating the new physical node to represent the new data node includes assigning the new data node to the position that is right or to the position that is left of one of the two existing nodes.

In some implementations, identifying the virtual node includes identifying two existing nodes to insert the new data node between, and determining, based on the labels of the two existing nodes, that the new data node cannot be inserted to either a position that is right or a position that is left of one of the two existing nodes. In such implementations, generating the new physical node to represent the new data node includes generating a new virtual node sub-tree, and assigning the new data node as a first physical node descendant of the new virtual node sub-tree.

In some implementations, node labels of the data structure are structured in an order representing a top-to-bottom, left-to-right traversal of the data structure.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is to say, methods in accordance with the present disclosure are not limited to the combinations of aspects and features specifically described herein, but also include any combination of the aspects and features provided.

Particular implementations of the subject matter described in this specification can be implemented so as to realize one or more of the following advantages. Implementations may provide a method for the representation of highly dynamic hierarchical data in RDBMSs. Implementations may provide high query and update performance while relying solely on basic INSERT, SELECT and DELETE statements. Implementations of the present disclosure may be inherently portable, which can be achieved, for example, by avoiding any dependencies on vendor-specific extensions.

The details of one or more embodiments of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example of an application tree, and a corresponding ICON tree according to implementations of the present disclosure.

FIG. 2 depicts example C-nodes of an ICON tree that have different k-values.

FIG. 3 depicts an example process of adding a child node to an empty position within an ICON tree according to implementations of the present disclosure.

FIG. 4 depicts an example process for adding a child node to the left of a leftmost physical node of an ICON tree according to implementations of the present disclosure.

FIG. 5 depicts an example process for adding a child node to the right of a rightmost physical node of an ICON tree according to implementations of the present disclosure.

FIG. 6 depicts an example process for adding a child node between two existing physical nodes of of an ICON tree according to implementations of the present disclosure.

FIG. 7 depicts a more complex example of an application tree and a corresponding ICON tree according to implementations of the present disclosure.

FIG. 8 shows the application tree from FIG. 7 with lower and upper bounds for each node as derived from an ICON tree according to implementations of the present disclosure.

FIGS. 9A and 9B show graphs representing experimental results for encoded labels of an ICON tree.

FIG. 10 depicts an example application tree with ICON lower and upper bounds generated from a corresponding ICON tree according to implementations of the present disclosure.

FIG. 11 is a flowchart illustrating an example process that can be executed in accordance with implementations of the present disclosure.

FIG. 12 is a schematic illustration of example computer systems that can be used to execute implementations of the present disclosure.

Like reference symbols in the various drawings indicate like elements.

### DETAILED DESCRIPTION

Implementations of the present disclosure include methods to efficiently represent hierarchical database data in a relational database. Furthermore, implementations of the present disclosure address the above-described problems in current hierarchical-to-relational database mapping systems. That is, the present disclosure provides methods for the representation of highly dynamic hierarchical data in RDBMSs that are portable, and provide high performance queries and navigation across hierarchical data. Implementations of the present disclosure achieve this in a processor- and memory-efficient manner.

More particularly, implementations of the present disclosure are directed to methods for storing and updating data in a hybrid data structure. The hybrid data structure is capable of storing highly dynamic hierarchical data, and efficiently mapping the data onto existing RDBMSs. In this manner, the strengths of both hierarchical and relational databases are leveraged. The data structure introduced by the present disclosure is referred to herein as an Interval Containment (“ICON”) tree. In general, an ICON tree is made up of physical nodes, and virtual nodes. Physical nodes correspond to data nodes of a hierarchical database that store particular data. Virtual nodes represent hierarchical relationships between two or more physical nodes. In some examples, virtual nodes serve as “hooks” that permit expansion of the ICON tree without affecting relational database labels of other existing nodes within the ICON tree. Furthermore, implementations of the present disclosure provide an efficient key generation mechanism for encoding the data hierarchy, while exploiting the DBMS's facility of indexing lexicographically ordered data.

In further detail, ICON can be described as a tree-labeling scheme with corresponding binary encoding. The labeling scheme assigns a label to each node in an ICON tree. The label encodes the node's position in the ICON tree. The ICON tree scheme is inherently stable. That is, insertions and deletions to the tree do not affect labels of existing nodes. For example, stability is achieved by representing an application tree (e.g., a data tree as a hierarchical database application sees it) as an ICON tree that contains “hooks” for future modifications. The “hooks” can be considered as expansion nodes. Node labels can be encoded as binary digits that, when ordered lexicographically, preserve the top-down, left-to-right traversal order of the hierarchical tree nodes.

In some implementations, ICON can be considered a containment-based labeling scheme, because it provides an efficient mechanism to derive so-called binary nested set interval boundary points from ICON labels. For example, conventional nested set models are not suitable for the representation of dynamic data, since insertions on average require the re-labeling of 50% of all nodes in a conventional nested set tree. By contrast, nested set interval boundary points from ICON labels (as discussed in reference to implementations of the present disclosure) are stable in case of updates and do not require re-labeling.

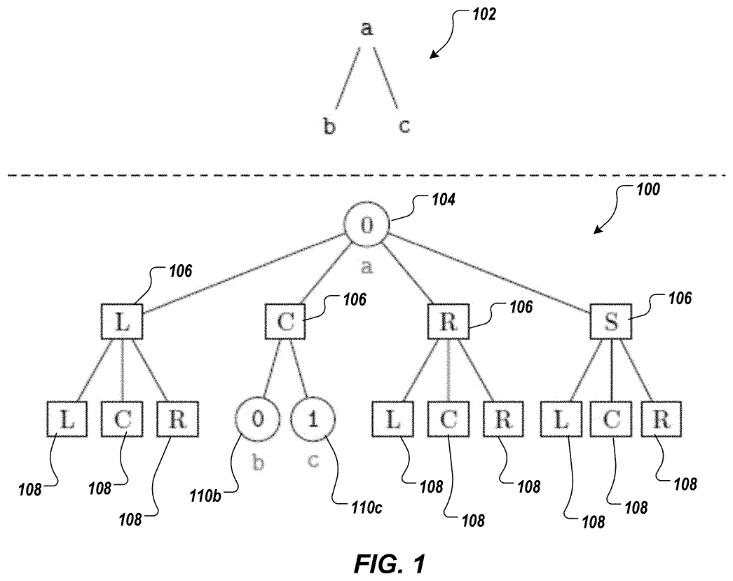

FIG. 1 depicts an example of an application tree 102, and a corresponding ICON tree 100. The application tree 102 is an application tree as seen by a traditional hierarchical database application, or system. In accordance with implementations of the present disclosure, the ICON tree 100 represents the application tree 102 as a tree that contains physical nodes (represented as circles), and virtual nodes (represented as squares). In the depicted example, the physical nodes of the ICON tree 100 that correspond to respective nodes of the application tree 102 are labeled with lowercase letters a, b, and c.

A physical node is a node within an ICON tree that corresponds to a node in the application tree 102 (e.g., nodes a, b, and c). Each physical node is associated with a positive integer number that defines a total order between a physical node, and any sibling nodes.

A virtual node is a node within an ICON tree that does not correspond to a node in the application tree. For example, virtual nodes may not have a particular meaning to a database application. Virtual nodes represent an implementation detail of the ICON labeling scheme. In some examples, each virtual node is associated with a symbol from a set {L, C, R, S}. Virtual nodes that are assigned the symbol L can be referred to as L-nodes. Virtual nodes that are assigned the symbol C can be referred to as C-nodes. Virtual nodes that are assigned the symbol R can be referred to as R-nodes. Virtual nodes that are assigned the symbol S can be referred to as S-nodes.

In some implementations, the ICON tree 100 has a fixed recursive structure that can be defined by the following: 1) the root node 104 is a physical node, 2) physical nodes have multiple (e.g., four) direct descendant nodes 106, 3) virtual nodes of type L, R, and S each have multiple (e.g., three) direct descendant nodes 108, and 4) virtual nodes of type C have 0 to 2^{k} direct descendant nodes 110 (where k is an integer value that is associated with each C-node). The direct descendant nodes 106 of a physical node are virtual nodes each of a type L, C, R, or S. In other words, each physical node has one of each type of virtual node as a direct descendant. The direct descendants of each L, R, and S virtual node are virtual nodes of a type L, C, or R. The direct descendants of each C-node are an integer number of physical nodes. Conceptually, the ICON tree 100 is infinite. However, for the sake of clarity, finite ICON trees are discussed herein. In some implementations, only physical nodes of an ICON tree 100 are stored in computer memory when an ICON tree 100 is persisted to memory (e.g., within a database system).

In some implementations, C-nodes provide the initial storage for children of a physical node. However, the storage provided by a C-node may fill up when the number of descendants of a given C-node reaches a limit for the C-node (e.g., 2^{k} descendants). As described in further detail herein, L-nodes and R-nodes provide hooks (e.g., overflow capacity) for future insertions of additional physical nodes to the left or right of the leftmost and rightmost physical node descendants of a given C-node. S-nodes provide a hook for the insertion of new sibling physical nodes between two existing physical nodes that are consecutively numbered.

Each node of the ICON tree can be represented by an ICON label. A node's ICON label describes the absolute path (using a decimal point “.” as separator character for better readability) from the root node 104 to the respective ICON node itself. For example, and with continued reference to FIG. 1, the ICON label of the physical node 110c that corresponds to node c of the application tree 102 is 0.C.1. In other words, the ICON label of a particular node can be considered a concatenation of the identities of each node along the path of the ICON tree from the root node 104 to the particular node itself. Thus, in the example ICON label for the physical node 110c (0.C.1) 0 represents the identity of the root node 104, C represents the identity of the first virtual node 106 as a C-node, and 1 represents the identity of the node 110c as physical node number 1 descended from the C-node 106.

Table 1 (below) shows the mapping between each of the nodes (a, b, and c) of the application tree 102, and the corresponding ICON labels for their respective physical nodes (104, 110b, 100c) in the ICON tree 100. The data shown in Table 1 fully defines the application tree 102, and its corresponding ICON tree 100. For example, only the labels of physical nodes must be persisted to store an ICON tree 100. Consequently, in some implementations, only the ICON labels of the physical nodes are stored in computer memory when storing an ICON tree 100.

TABLE 1
Nodes of the application tree 102 of FIG. 1, and corresponding ICON
labels.

| Node | ICON label |
|---|---|
| a | 0 |
| b | 0.C.0 |
| c | 0.C.1 |

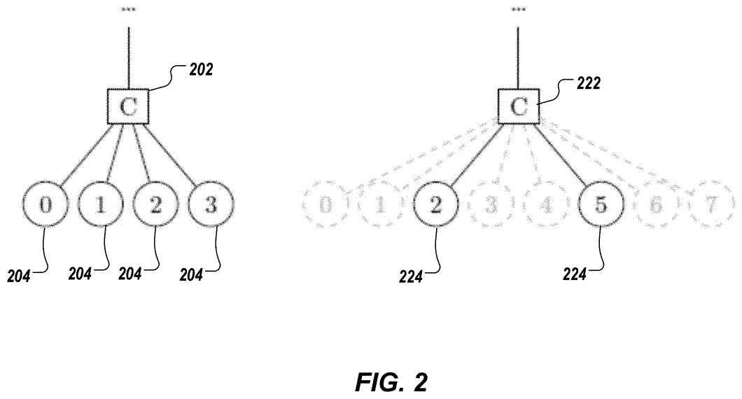

FIG. 2 depicts example C-nodes of an ICON tree that have different k-values. Each C-node is associated with an integer k>0 that is used to specify an upper bound 2^{k} for the number of direct physical node descendants accommodated by the C-node. For example, a C-node 202 has a k-value of 2, and a C-node 222 has a k-value of 3. The child nodes are organized in a fixed-size array with absolute positioning. In other words, k represents the number of bits that will be used to encode the position of each physical node in the array. For example, the C-node 202, with k=2, has four child nodes 204 at positions 0, 1, 2 and 3.

In some implementations, the array of child nodes associated with a C-node can be sparse, and children can be located at any position along the array. For example, the C-node 222, with k=3, has children 224 at positions 2 and 5. The C-node 222 also has six empty child node positions (represented by dashed lines) at positions 0, 1, 3, 4, 6, and 7. The following figures will not indicate empty positions to avoid confusion.

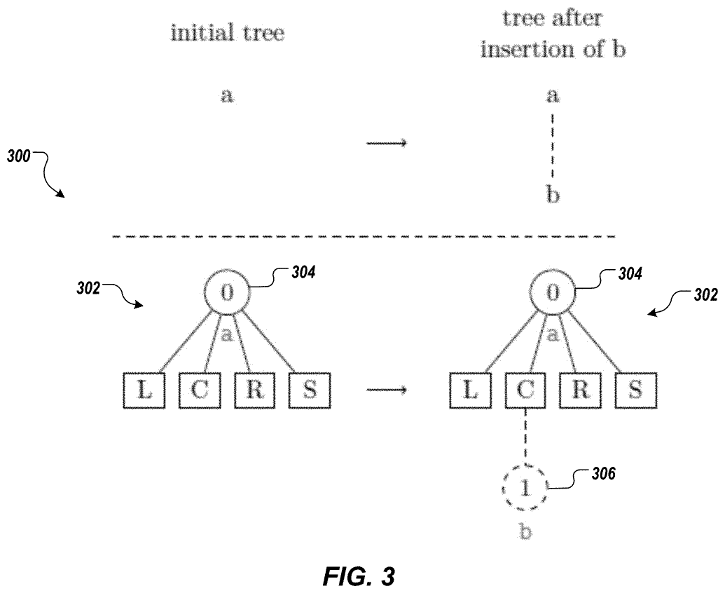

Techniques for the selection of k-values can impact the amount of data storage required to represent ICON tree nodes as compact binary nested set interval boundary points. Such techniques are described in further detail herein. However, for the sake of clarity, the discussion of FIGS. 3-8 will assume a constant value of k=2.

Implementations for insertion of physical nodes into an ICON tree are now described. At the outset, the ⊕ symbol is used herein to indicate the concatenation of an ICON label (left operand) with a component that represents a virtual or physical node (right operand). In addition, the ⊕ symbol can also indicate the decomposed structure of an ICON label. For example, 0.C.1⊕C⊕0 yields the label 0.C.1.C.0.

FIG. 3 depicts an example process 300 of adding a child node to an empty position within an ICON tree. For example, the process 300 may represent the insertion of the first child for a physical node with label X. FIG. 3 illustrates an ICON tree 302 that includes a physical node 304, and its direct descendant nodes (e.g., virtual nodes L, C, R, and S). The new child node 306 is inserted at any of the 2^{k} positions of the C-node that is the direct descendant of node 304. Symbolically, the insertion can be represented by X⊕C⊕p, where X is the label for physical node 304, and p represents any one of the 2^{k} positions of the C-node to which the new child node 306 may be assigned, where p is a non-negative integer in range [0, 2^{k}), i.e., pϵ{xϵ [symbol] ₀|⁰≤x<2^{k}}. For example, and as depicted in FIG. 3, the new child node 306 is inserted at position 1 of the C-node, and the insertion can be represented by X⊕C⊕1.

The example code listing below (Listing 1), shows the corresponding pseudo-code for inserting a child node into an empty ICON tree position. The example code assumes that a method positionForFirstChild is defined that, given the label of a C-node, yields the position for the first child. For example, if executed for the ICON tree 302 shown in FIG. 3 the method positionForFirstChild (X⊕C) may return a value of 1, indicating position 1 of the C-node.

Listing 1: Pseudo-code for the insertion of
the first child of a node with label X.

| | |
|---|---|
| 1: | def insertFirstChild (label: X) |
| 2: | return X ⊗ C ⊗ positionForFirstChild (X ⊗ C) |

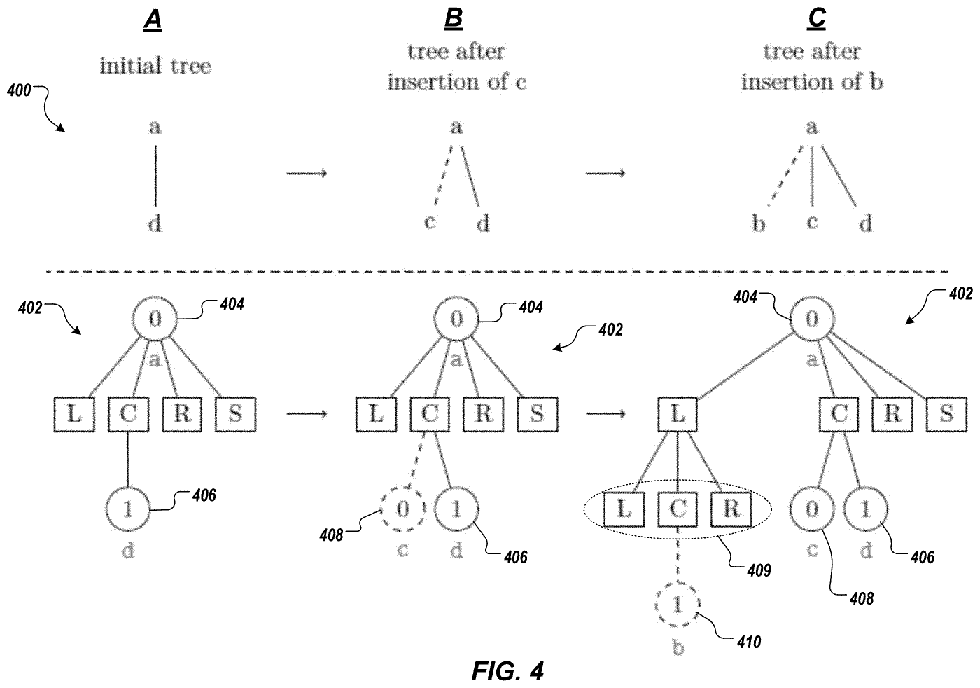

FIG. 4 depicts an example process 400 for adding a child node to the left of a leftmost physical node of an ICON tree. FIG. 4 shows an ICON tree 402 that includes a physical node 404, and its direct descendant nodes (e.g., virtual nodes L, C, R, and S). In the depicted example, the node 404 already has one child node, node 406 in position 1 of node 404's C-node. The ICON label of the node 404 is generically represented as X.

The process 400 illustrates two consecutive insertions to the left of a leftmost sibling of ICON tree 402. Diagrams A and B illustrate the insertion of a node 408 (ICON label X⊕C⊕0) to the left of the node 406 (ICON label X⊕C⊕1). Diagrams B and C illustrate the insertion of a node 410 (ICON label X⊕L⊕C⊕1) to the left of the node 408.

More specifically, the process 400 illustrates two possible scenarios of the insertion of a new sibling to the left of a leftmost sibling node s at position p with label X⊕C⊕p (e.g., the ICON label of the node 406 is generally represented as X⊕C⊕p, where p=1 in the example shown in FIG. 4). In the first scenario, let p>0 (diagrams A and B). That is, the leftmost sibling node s is not located at the leftmost position of the C-node. For example, in diagram A, the node 406 is at position 1, which leaves one empty position available to the left of the node 406 (e.g., position 0). Therefore, the new sibling node s can be added to the ICON tree 402 by inserting the node 408 at the empty position to the left of the node 406, for example, at position p−1 (e.g., position 0), as shown in diagram B.

In the second scenario, let p=0 (diagrams B and C). That is, the leftmost sibling node s is located at the leftmost position of the C-node. For example, in diagram B, the node 408 is at position 0, which is the leftmost position since physical nodes are not permitted to hold negative integer values. To add another new sibling node, the insertion “overflows” into X⊕L⊕C by generating a new C sub-tree below X⊕L. For example, a sub-tree 409 is generated, and the node 410 is added as a sibling at position 1 of the new C-node in the sub-tree 409.

The example code listing below (Listing 2), shows the corresponding pseudo-code for inserting a child node to the left of the leftmost sibling node in an ICON tree.

Listing 2: Pseudo-code for the insertion of a new node to the left
of a leftmost sibling with label X ⊗ C ⊗ p.

| | |
|---|---|
| 1: | def insertToTheLeft (X ⊗ C ⊗ p) |
| 2: | if p > 0: |
| 3: | return X ⊗ C ⊗ p−1 |
| 4: | else: |
| 5: | return X ⊗ L ⊗ C ⊗ positionForFirstChild(X ⊗ L ⊗ C) |

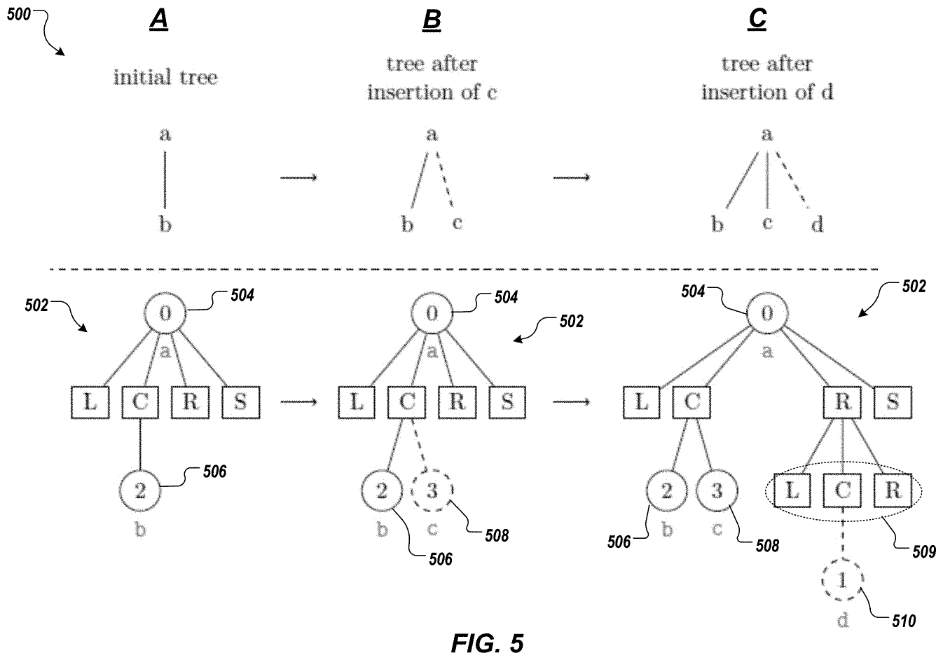

FIG. 5 depicts an example process 500 for adding a child node to the right of a rightmost physical node of an ICON tree. FIG. 5 shows an ICON tree 502 that includes a physical node 504, and its direct descendant nodes (e.g., virtual nodes L, C, R, and S). The node 504 has one child node, a node 506, in position 2 of node 504's C-node. The ICON label of the node 504 is generically represented as X.

The process 500 illustrates two consecutive insertions to the right of a rightmost sibling of the ICON tree 502. Diagrams A and B illustrate the insertion of a node 508 (ICON label x⊕C⊕3) to the right of the node 506 (ICON label x⊕C⊕2). Diagrams B and C illustrate the insertion of a node 510 (ICON label X⊕R⊕C⊕1) to the right of the node 508.

More specifically, the process 500 illustrates two possible scenarios for the insertion of a sibling to the right of a rightmost sibling node sat position p with label X⊕C⊕p (e.g., the ICON label of the node 506 is generally represented as X⊕C⊕p, where p=2 in the example shown in FIG. 5). In the first scenario, let p<2^{k}−1 (diagrams A and B). That is, the rightmost sibling node s is not located at the rightmost position of the C-node. For example, in diagram A, the node 506 is at position 2, which leaves one empty position available to the right of the node 506 (e.g., position 3 where k=2). Therefore, the sibling node s can be added to the ICON tree 502 by inserting the node 508 at the empty position to the right of the node 506, for example, at position p+1 (e.g., position 3), as shown in diagram B.

In the second scenario, let p=2^{k}−1 (diagrams B and C). That is, the rightmost sibling node s is located at the rightmost position of the C-node. For example, in diagram B, the node 508 is at position 3, which is the rightmost position, when k is 2. To add another sibling node, the insertion “overflows” into X⊕R⊕C by generating a C sub-tree below X⊕R. For example, a sub-tree 509 is generated, and a node 510 is added as a sibling at position 1 of the new C-node in the sub-tree 509.

The example code listing below (Listing 3), shows the corresponding pseudo-code for inserting a child node to the right of the rightmost sibling node in an ICON tree. The pseudo-code assumes that there is a method nodeIsAtRightMostPosition that, for a given label, determines whether the corresponding node is at the rightmost position for a given C-node. For example, the method nodeIsAtRightMostPosition can compare the position of a node identified by the ICON label provided as an argument (e.g., X⊕C⊕p) to the maximum number of physical nodes permitted by the associated C-node, and given by 2^{K}.

Listing 3: Pseudo code for the insertion of a new node to the right
of a rightmost sibling with label X ⊗ C ⊗ p.

| | |
|---|---|
| 1: | def insertToTheRight(label: X ⊗ C ⊗ p) |
| 2: | if nodeIsAtRightMostPosition(label): |
| 3: | return X ⊗ R ⊗ C ⊗ positionForFirstChild(X ⊗ R ⊗ C) |
| 4: | else: |
| 5: | return X ⊗ C ⊗ p+1 |

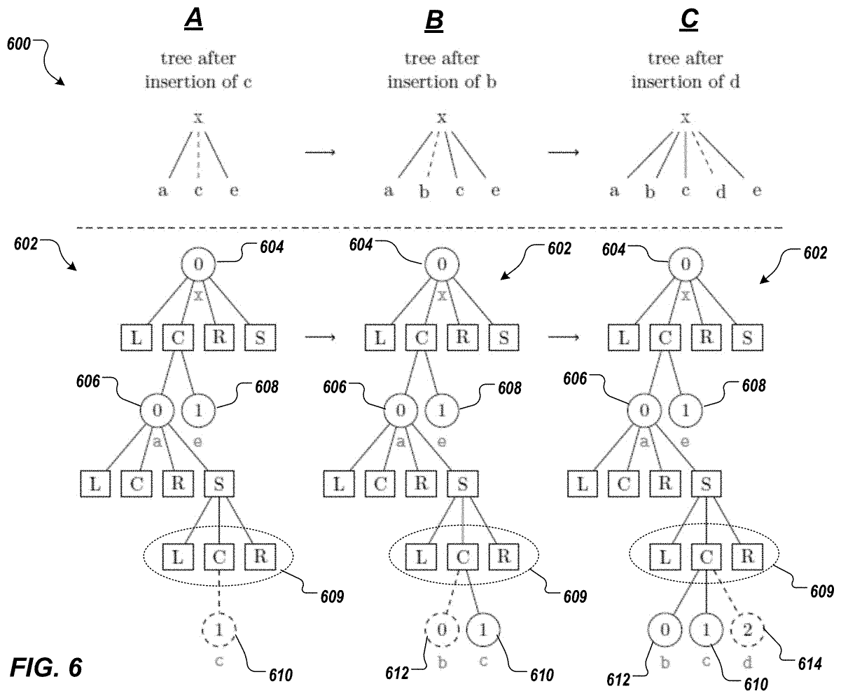

FIG. 6 depicts an example process 600 for adding a child node between two existing physical nodes of an ICON tree. FIG. 6 shows an ICON tree 602 that includes a physical node 604, and its direct descendant nodes (e.g., virtual nodes L, C, R, and S). The ICON label of the node 604 is generically represented as X. The node 604 already has two children nodes, a node 606 in position 0 of node 604's C-node, and a node 608 in position 1 of the node 604's C-node. The node 606 has an ICON label of x⊕C⊕0, and the node 608 has an ICON label of x⊕C⊕1.

For intermediate insertions, an order of ICON labels is defined. The following example definition uses the notation |l| to indicate the length of an ICON label l, which corresponds to the number of label components separated by decimal points. For example, |0|=1 and |0.C.1|1=3. The i th component of a label l is indicated as l[i]. Label indexing is 1-based. For example 0.C.1[1]=0 and 0.C.1[2]=C.

Individual label components can be compared based on an integer value that is assigned to each component. The integer value for a component that corresponds to a physical node p is its position p. The integer value for a component that corresponds to a virtual node is as follows: 0 for a L-node, 1 for a C-node, 2 for a R-node, and 3 for a S-node.

As used herein, the notation <represents a comparison between two ICON labels. For example, the notation l<r indicates that ICON label l is smaller than ICON label r. An ICON label l is smaller than another ICON label r (l<r) if one of the following conditions holds:

1. l is a real prefix of r:|l|<|r| and l[i]=r[i] for each iϵ{1,K,|l|}; OR

2. l and r share a common prefix of length n, but the n+1th component of l is smaller than the nth component of r:nϵ{1, min(|l|, |r|)−1} such that l[i]=r[i] for each iϵ{1,K, n} and l[n+1]<r[n+1]. For example, ICON labels ordered according to above definition are:
0<0.L<0.C<0.C.1<0.C.2<0.C. 10<0.C.10.C.1<0.R<0.S.

The process 600 illustrates three insertions between existing physical nodes of the ICON tree 602. Diagram A illustrates the insertion of a node 610 (ICON label X⊕C⊕0⊕S⊕C ⊕1) between the node 606 (ICON label X.C.0), and the node 608 (ICON label X⊕C⊕1). Diagram B illustrates the insertion of a node 612 (ICON label X⊕C⊕0⊕S⊕C⊕0) between the node 606 (X⊕C⊕0), and the node 610 (ICON label X⊕C⊕0⊕S⊕C⊕1). Diagram C illustrates the insertion of a node 614 (ICON label X⊕C⊕0⊕S⊕C⊕2) between the node 610 (ICON label X⊕C⊕0⊕S⊕C⊕1), and the node 608 (ICON label X⊕C⊕1).

More specifically, the process 600 illustrates three possible scenarios for the insertion of a sibling node between existing sibling nodes. For discussion, the existing sibling nodes in each scenario will be respectively referred to as a left-bounding node, and a right-bounding node. That is, a sibling node will be inserted between the left-bounding node, and the right-bounding node. For example, when the node 610 is inserted between the nodes 606, 608 in diagram A, the node 606 serves as the left-bounding node, and the node 608 serves as the right-bounding node.

In some examples, when executing the process 600, a computing system determines whether a new C sub-tree should be spawned. In some examples, new C sub-trees are spawned from S-nodes below the left-bounding sibling node. There are three possible scenarios for the insertion of a sibling node between bounding sibling nodes with label leftbound=Xₗ⊕C⊕pₗ and rightbound=Xᵣ⊕C⊕pᵣ.

In a first scenario, if the label l that would be generated by inserting to the right of the left-bounding node would be smaller than the label of the right-bounding node, there is no need to spawn a new C sub-tree (e.g., insertToTheRight(leftbound)<rightbound). Instead, the sibling node can be inserted between the right-bounding node, and the left-bounding node by inserting a sibling to the right of the left-bounding node (e.g., as in diagram C).

In a second scenario, if the label of the left-bounding node would be smaller than the label l that would be generated by inserting to the left of the right-bounding node, then there is also no need to spawn a new C sub-tree (e.g., leftbound<insertToTheLeft(rightbound)). Instead, the sibling can be inserted between the right-bounding node, and the left-bounding node by inserting a sibling to the left of the right-bounding node (e.g., as in diagram B).

In a third scenario, if neither of the above two scenarios holds, then a new C sub-tree is spawned to insert the new sibling (e.g., as in diagram A). For example, referring to diagram A, the node 610 is to be inserted between the nodes 606, 608. In testing the first condition, insertToTheRight(X.C.0) of the node 606 would produce a label (X⊕C⊕1) that is not smaller than the label of node 608 (X⊕C⊕1), but is equal to the label of the node 608. In testing the second condition, insertToTheLeft(X⊕C⊕1) of the node 608 would produce a label (X⊕C⊕0) that is not larger than the label of the node 606 (X⊕C⊕0), but is equal to the label of the node 606. Therefore, the insertion “overflows” into Xₗ⊕C⊕pₗ⊕S⊕C by spawning a C sub-tree (e.g., the sub-tree 609) below the left-bounding node (the node 606) at Xₗ⊕C⊕pₗ⊕S. The new sibling node 610 is added at position 1 of the new C-node in sub-tree 609.

Diagram B represents an example where the second scenario holds. For example, the node 612 is to be inserted between the nodes 606, 610. In testing the first condition, insertToTheRight(X⊕C⊕0) of the node 606 would produce a label (X⊕C⊕1) that is not smaller than the label of the node 610 (X ⊕C⊕0⊕S⊕C⊕1), but is larger than the label of the node 610. In testing the second condition, insertToTheLeft(X⊕C⊕0⊕S⊕C⊕1) of the node 610 would produce a label (X⊕C⊕0⊕S ⊕C ⊕0) that is larger than the label of node 606 (X⊕C⊕0). So, the new sibling node 612 can be added at position 0 of the C-node in the sub-tree 609 (e.g., to the left of the node 610).

Diagram C represents an example of where the first scenario holds. For example, a node 614 is to be inserted between the nodes 610, 608. In testing the first condition, insertToTheRight(X⊕C⊕0⊕S⊕C⊕1) of the node 610 would produce a label (X⊕C⊕0⊕S⊕C⊕2) that is smaller than the label of the node 608 (X ⊕C⊕1). So, the new sibling node 614 can be added at position 2 of the C-node in the sub-tree 609 (e.g., to the right of the node 610).

The example code listing below (Listing 4), shows the corresponding pseudo-code for inserting a child node between existing sibling nodes in an ICON tree.

Listing 4: Pseudo-code for the insertion of a sibling
between existing siblings left and right.

| | |
|---|---|
| 1: | def insertInBetween(left: Xₗ ⊗ C ⊗ pₗ, right: Xᵣ ⊗ C ⊗ pᵣ) |
| 2: | if insertToTheRight(left) < right: |
| 3: | return insertToTheRight(right) |
| 4: | if left < insertToTheLeft(right): |
| 5: | return insertToTheLeft(right) |
| 6: | return Xₗ ⊗ C ⊗ pₗ ⊗ S ⊗ C ⊗ positionForFirstChild(Xₗ ⊗ C ⊗ pₗ ⊗ S ⊗ C) |

A physical node n can be deleted by deleting its ICON label from memory, and removing any physical descendant nodes of node n (e.g., physical children of n). For example, as discussed above, ICON trees are fully defined by the labels of their physical nodes. In order to delete a physical node n with label X, n's label X is deleted from memory, and all physical nodes in n's sub-trees X⊕L, X⊕C and X⊕R are recursively deleted.

Implementations of the present disclosure also provide binary encoding of ICON labels. More particularly, to efficiently store the ICON labels for an ICON tree in memory, the labels can be encoded as binary digits. Implementations of the binary encoding of the ICON labeling scheme ensure that the lexicographic order of the binary strings preserves the order of the corresponding ICON labels. The following example process for binary encoding also enables ICON labels to be represented in hexadecimal format, while preserving the ordering between labels.

The ICON binary encoding bin(X) for an ICON label X can be derived by replacing each component of X according to the following example process. The root node is replaced with an empty binary string (Ø). Each virtual node is replaced with a corresponding m-bit (e.g., 2-bit) constant. An example of this is depicted in Table 2 below. Each physical node p, other than the root node, is replaced with its respective binary representation using k-bits, where k is a property of the respective parent C-node. In some examples, the binary encoded representation of each physical node represents the node's left-to-right position among its siblings.

TABLE 2
Encodings for Virtual Nodes.

| Virtual Node | Encoding |
|---|---|
| L | 00 |
| C | 01 |
| R | 10 |
| S | 11 |

For example, the binary encoding for the example label 0.R.C.3 is 11.01.11 (with the decimal points being introduced for readability). The root node (0) is replaced by the empty binary string (Ø), and so is not shown. The first two bits (11) represent the binary encoding for R. The next two bits (01) represent the binary encoding for C. The last two bits (11) represent the binary encoding of the physical node (3) using 2-bits (e.g., the example assumes that the C-node 0.R.C has a k-value of 2). None of the bits in 11.01.11 corresponds to the root note 0, since the root node is replaced with the empty binary string.

The notation l<ₗₑₓ r indicates that a binary string/is lexicographically smaller than a binary string r. For example, the lexicographic order of the binary strings 0, 1, 11 and 100 is 0<lₑₓ 1<lₑₓ 100<lₑₓ 11. The binary encoding scheme for ICON labels described herein ensures that the order for ICON labels (discussed above) is preserved for lexicographic ordering of the binary encoded counterparts. Furthermore, the encoding for virtual nodes shown in Table 1 ensures that, for a given label X, the following inequalities hold:
bin(X)<ₗₑₓ bin(X⊕L)<ₗₑₓ bin(X⊕C)<ₗₑₓ bin(X⊕R)<ₗₑₓ bin(X⊕S).

The above inequalities can be read as: After visiting a node with label X, we will (a) visit descendants in the L-sub-tree (b) followed by descendants in the C-sub-tree (c) followed by descendants in the R-sub-tree (d) followed by descendants in the S-sub-tree. For example, according to the above inequalites, the binary encoded ICON labels are sorted in ascending order, such that traversal of the related ICON tree begins at node X, proceeds to the child-nodes in the L-sub-tree; followed by child-nodes in the C-sub-tree; followed by child-nodes in the R-sub-tree; followed by siblings in the S-sub-tree.

As another example, for an ICON label X with bin(X)=010, the above inequalities can be rewritten as follows:

$${\underbrace{010}}_{bin ( X )} {<}_{lex} {\underbrace{010.00}}_{bin ( X ⊗ L )} {<}_{lex} {\underbrace{010.01}}_{bin ( X ⊗ C )} {<}_{lex} {\underbrace{010.10}}_{bin ( X ⊗ R )} {<}_{lex} {\underbrace{010.11}}_{bin ( X ⊗ S )}$$

Using a fixed k-value to encode all sibling physical nodes ensures that siblings below a C-node are traversed in the correct order. In other words, for two siblings X⊕C⊕pₗ and X⊕C⊕p, with pₗ<pᵣ, it follows that bin(X⊕C⊕pₗ)<ₗₑₓ bin(X⊕C⊕pᵣ). Further, the above inequalities ensure traversal of the ICON tree from top-to-bottom, and left-to-right.

For example, consider the labels 0.C.2, 0.C.3 and 0.C.4 where the C-node has a k-value of 3. Using a fixed k-value to encode each physical node below the C-node ensures that the lexicographic order of the bit strings preserves the sequential order of the ICON nodes:

$${\underbrace{01.010}}_{bin ( 0. C .2 )} {<}_{lex} {\underbrace{01.011}}_{bin ( 0. C .3 )} {<}_{lex} {\underbrace{01.100}}_{bin ( 0. C .4 )}$$

For example, an encoding bin′ that does not encode children of a C-node with a fixed number of bits may result in binary strings that do not preserve the sequential order of the corresponding nodes:

$${\underbrace{01.10}}_{bin ( 0. C .2 )} {<}_{lex} {\underbrace{01.100}}_{bin ( 0. C .4 )} {<}_{lex} {\underbrace{01.11}}_{bin ( 0. C .3 )} \} invalid encoding$$

In some implementations, boundary points (refered to herein as “Nested Set Interval Boundary Points” (NSIBP)) are defined for each physical node. NSIBPs represent the lower and upper ICON label bounds for all possible children of a physical node. As such, NSIBPs leverage the top-to-bottom and left-to-right traversal of hierarchical trees preserved by the ICON labeling scheme to provide accurate, and efficient boundary references that encapsulate all hierarchically related nodes.

NSIBPs include an ICON lower bound and an ICON upper bound. The NSIBP lower bound is defined as bin(X) for a node with label X. The ICON lower bound can be referred to as lower (X). The ICON upper bound is defined as bin(X⊕S) for a node with label X. The ICON lower bound can be referred to as upper (X).

The above definitions exploit the fact that, for a node with label X, each descendant must have a label Y with bin(X)<ₗₑₓ bin(Y). This follows from the fact that descendants are either located in the X⊕L, X⊕C or X⊕R sub-tree. Furthermore, bin(X⊕S) is a proper NSIBP upper bound, because the S sub-tree only stores ‘coerced’ siblings. The following corollaries formalize the intuitive description from above:

Corollary 1: Let l and r be two nodes in an ICON tree with labels L and R. l will appear before r in a top-down left-to-right traversal order, if and only if lower(L)<ₗₑₓ lower(R)

Corollary 2: Let a and d be two node in an ICON tree with labels A and D. d is a descendant of a, if and only if lower(A)<ₗₑₓ lower(D)<ₗₑₓ upper(A).

Implementations of the present disclosure further provide for decoding of binary encoded ICON labels. In some examples, binary encoded ICON labels are decoded from left-to-right by separating the bits into individual bit strings that each represent a component of the ICON label. In a sense, the decoding starts at the root node. However, in practice, the decoding starts at the first descendant of the root node, because the root node is encoded as an empty bit string. In other words, because the first component of an ICON label is always a physical root node that is encoded using an empty bit string, 0 is assigned as first component of the decoded ICON label. The first two bits of the binary label will form the second component of the ICON label, because each physical node must have a virtual node as a direct descendant, and virtual nodes are only encoded with two bits. The node-type of each subsequent component in the binary label can be determined based on the node-type of the currently decoded label component. Further, the length of a subsequent bit string in the binary label can be determined based on the identified node-type of the currently decoded component. In other words, decoding a bit string for one component reveals the bit string length of the next subsequent ICON label component. For example, a virtual node having a 2-bit string will always follow an L-node (binary 00), an R-node (binary 10), an S-node (binary 11), and a physical node (bit string length of k). Therefore, if the currently decoded bit string represents an ICON label for either an L-node, an R-node, an S-node, or a physical node the bit string for the next ICON label component will be 2-bits long. Furthermore, a physical node will always follow a C-node (binary 01). The bit string length for a physical node following a C-node will be equal to the k-value of the C-node. For example, if k=3 for all C-nodes in a given ICON tree, the bit string length following each C-node will be 3 bits. A process for determining k values in implementations where k-values are variable will be discussed in more detail below. For the purpose of the present discussion, k-values are assumed to be constant for a given ICON tree.

For example, the binary label 01001 can be decoded as the ICON label 0.C.1 assuming a constant k-value of 3. Because the first component of an ICON label is always a physical node that is encoded using an empty bit string, 0 is assigned as first component of the decoded ICON label. In other words, the actual integer value does not have any meaning in this case, because there can be only one root element. Each physical node (including the root node) has only virtual nodes of type L, C, R and S as descendants. Accordingly, the first two bits of 01001 represent the bit string for the next ICON label component (e.g., the label of the next ICON node). Thus, the 2-bit string 01 is identified as the bit string representation of the next ICON label component. Further, the binary label can be segmented as 01.001. The 2-bit string 01 is then decoded as a C-node giving a partially decoded ICON label of 0.C. The decoded C-node also reveals that the next subsequent node will be a physical node. Furthermore, since C-nodes of the ICON tree in the present example have a constant k-value equal to 3, the ICON label of the physical node will be encoded in a 3-bit long bit string. Therefore, the last 3 bits represent the binary encoding of a physical node 1, resulting in a fully decoded ICON label of 0.C.1.

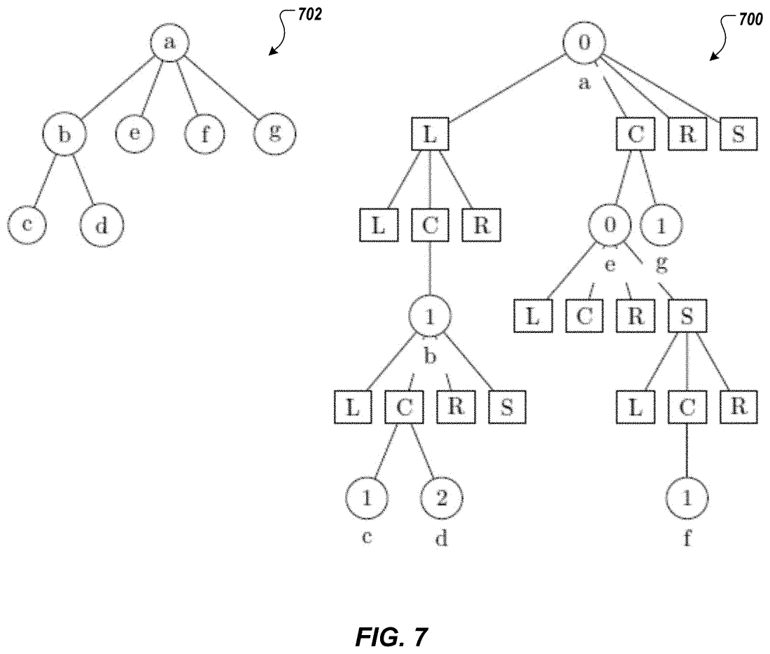

FIG. 7 depicts a more complex example of an application tree 702 and a corresponding ICON tree 700. The ICON tree 700 includes an overflow to the left. For example, the node b (ICON label 0.L.C.1) is a left overflow from the root node, node a. The ICON tree 700 also includes a sibling node that has been “coerced” between two other nodes. For example, the node f (ICON label 0.C.0.S.C.1) has been inserted between the node e (ICON label 0.C.0) and the node g (ICON label 0.C.1). The complexity of this example is sufficient to cover all aspects of the ICON binary encoding. Table 3 (below) lists the ICON label and the NSIBP lower and upper bounds for each physical node a-g of the ICON tree 700. Note that the binary labels in Table 3 assume a constant 2-bit k-value for the C-nodes in the ICON tree 700.

TABLE 3
ICON labels and their NSIBP lower and upper bounds.

| Node | ICON Label (L) | lower (L) | upper (L) |
|---|---|---|---|
| a | 0 | Ø | 11 |
| b | 0.L.C.1 | 00.01.01 | 00.01.01.11 |
| c | 0.L.C.1.C.1 | 00.01.01.01.01 | 00.01.01.01.01.11 |
| d | 0.L.C.1.C.2 | 00.01.01.01.10 | 00.01.01.01.10.11 |
| e | 0.C.0 | 01.00 | 01.00.11 |
| f | 0.C.0.S.C.1 | 01.00.11.01.01 | 01.00.11.01.01.11 |
| g | 0.C.1 | 01.01 | 01.01.11 |

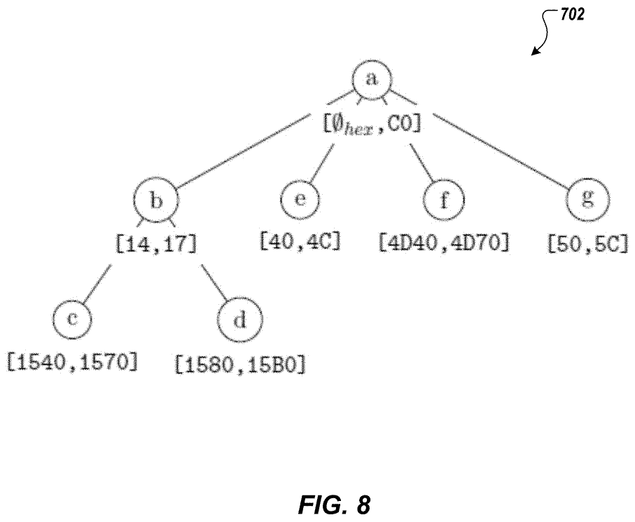

FIG. 8 shows the application tree 702 from FIG. 7 with NSIBP lower and upper bounds for each node as derived from the ICON tree 700. The NSIBP lower and upper bound bit strings have been replaced with hexadecimal strings (Øₕₑₓ represents the empty string). The hexadecimal strings can be derived from binary strings, for example, by padding the binary strings with trailing zeros until the number of bits is a multiple of eight. The zero padded binary strings can be converted to hexadecimal strings by converting each set of four bits in the binary string into a corresponding hexadecimal character.

Sorting the ICON lower bounds in lexicographical order (e.g., assuming the ordering of hexadecimal characters is [0,K,9, A, B,K, E, F]) will order the nodes in top-down left-to-right traversal order of the ICON tree 702 (e.g., Øₕₑₓ<ₗₑₓ 14<ₗₑₓ 1540<ₗₑₓ 1580<ₗₑₓ 40<ₗₑₓ 4D40<ₗₑₓ 50). All descendant nodes d of an ancestor node a meet the inequality:
lower(a)<ₗₑₓ lower(d)<ₗₑₓ upper(a).
   For example, the the labels of both the node c and the node d fall between the lower and upper bounds of node b, e.g., 14<ₗₑₓ 1540<ₗₑₓ 1580<ₗₑₓ 17. Therefore, the descendants of any given node n can be efficiently determined by sorting a set of node labels and identifying all of the nodes that lie between node n's NSIBP lower and upper bounds.

Implementations of the present disclosure further provide for various processes of encoding physical nodes. In some examples, encoding for physical nodes can be performed using processes to track the number of bits used to encode the binary labels for physical nodes in an ICON tree (e.g., C-node k-values) and to select a position within a C-node array for the first child of a given C-node. These processes can be represented by two example functions: bitCount and positionForFirstChild.

In some examples, the functions bitCount and positionForFirstChild can have the following semantics:

bitCount: Given a C-node with label X, bitcount returns the number of bits to use when encoding the position of child nodes of the C-node. In other words, bitCount returns the C-node k-value. In order to allow the decoding of encoded labels, bitcount is deterministic. For a given label X, consecutive invocations of bitCount(X) yield the same result.
positionForFirstChild: Given a C-node with a label X, positionForFirstChild(X) returns the position of the first child node below the node identified by the label X.

In some implementations, C-node k-values can be constant for a given ICON tree. In such implementations, the binary label for each physical node can be encoded using the same number of bits. Furthermore, the position of the first C-node child can also be a constant value in such implementations. In such implementations, the bitCount and positionForFirstChild functions would return the respective constant values fork and the first child node position. For example, if a constant k-value of 2 and a constant first node position of 1 are chosen the functions can be:

1. bitCount(X)=2

2. positionForFirstChild(X)=1.

The above function definitions can be read as each C-node can hold up to 4 child nodes and the first child of a C-node is always inserted at position 1.

However, as demonstrated below, using a constant k-value can result in consecutive overflows to the left or right. Excessive overflows can cause ICON labels to grow linearly as the number of sibling nodes increases, which, depending on a database size, may result in excessive memory usage, poor query performance, high query response times, or a combination thereof. For example, Table 4 (below) lists example labels that are generated by eight consecutive insertions to the right of a node with the label 0.C.1. The data in Table 4 assumes a constant k-value of 2. The data in Table 4 shows an overflow to the right after every third insertion. The frequent overflows result in bounds that grow on average % bits per insertion.

TABLE 4
Linear growth of bounds due to constant
bitCount and positionForFirstChild functions.

| Label | Lower Bound |
|---|---|
| 0.C.1 | 01.01 |
| [symbol] | [symbol] |
| 0.C.3 | 01.11 |
| 0.R.C.1 | 10.01.01 |
| [symbol] | [symbol] |
| 0.R.C.3 | 10.01.11 |
| 0.R.R.C.1 | 10.10.01.01 |
| [symbol] | [symbol] |
| 0.R.R.C.3 | 10.10.01.11 |

In some implementations, variable k-values can be used to avoid the aforementioned linear growth of label sizes. In some examples, using variable k-values may also provide more compact lower and upper bounds for applications with ordered and random insertion characteristics. For example, the k-value can be incremented for each C-node that is generated as the result of an overflow. In such implementations the bitCount function can be used to generate incremental k-values and compute the k-values of existing nodes. For example, the bitCount function can use a variable to keep track of a bit count while scanning the components of an ICON label from left-to-right. The bit count can be initialized with an initial value (e.g., 1). Each time a left or right overflow is detected (e.g., a ICON label component for an L-node or R-node is traversed), the bit count can be increased by an increment value (e.g., 1, 2, 5). When a C-node is reached, the current bit count is assigned as the C-node k-value. In such an implementation regions of an ICON tree that are subject to frequent overflows (frequent insertions) are efficiently detected and the size of subsequent C-node arrays is adjusted to accommodate the frequent insertions.

In some implementations, the bit count can be reset to the initial value under specified conditions in order to avoid excessively large k-values. For example, ICON label growth may be predominantly affected by the addition of sibling nodes. Therefore, when traversing down a tree to the next level of descendants with no further overflows it is not necessary to have a large k-value for the initial descendants. In some examples, the initial k-value can be used for C-nodes that are direct descendants of physical nodes. Similarly, it may be less likely to have repeated insertions between two existing nodes so the initial k-value can also be used for C-nodes that are direct descendants of S-nodes. Consequently, in some examples, the ICON labels of physical nodes and S-nodes can be reset flags that cause the bitCount function to reset the bit count to the initial value when these nodes are traversed while scanning an ICON label.

For example, a general algorithm for bitCount can be represented by the following rules:

1. Initialize the initial bit count at a predetermined value (e.g., 1).

2. Scan the components of an ICON label (e.g., label X) from left-to-right.

3. If the current component represents an L-node or an R-node increment the bit count by an increment value.

4. If the current component represents an S-node reset the bit count to the initial value (e.g., 1).

5. If the current component represents a physical node reset the bit count to the initial value (e.g., 1).

6. Return the value of the bit count after processing the final component of the ICON label.

In some implementations, the bit count increment value itself can be variable. For example, the increment value can increase based on the current bit count value. For example, the increment value can be 1 if the current bit count is 1 and 2 if the bit count is greater than 1.

Table 5 shows six ICON labels and the corresponding value computed by bitcount(X) using the rules described above and incorporating a variable increment value.

TABLE 5
Bit counts generated by the example rules above.

| X | bitCount (X) | Comment |
|---|---|---|
| 0.C | 1 | initial bit count of 1 |
| 0.L.C | 2 | overflow: current count of 1 is increased by 1 |
| 0.L.R.C | 4 | overflow: current count of 2 is increased by 2 |
| 0.L.R.R.C | 6 | overflow: current count of 4 is increased by 2 |
| 0.C.1.S.C | 1 | S-node resets the bit count to 1 |
| 0.L.C.1.C | 1 | physical node 1 resets the bit count to 1 |

Because the bit count value increases in the case of an overflow, some implementations can assign the first child node to the middle position. For example, positionForFirstChild can be represented as:

$$positionForFirstChild ( X ) = \frac{{2}^{bitCount ( X )}}{2} - 1.$$

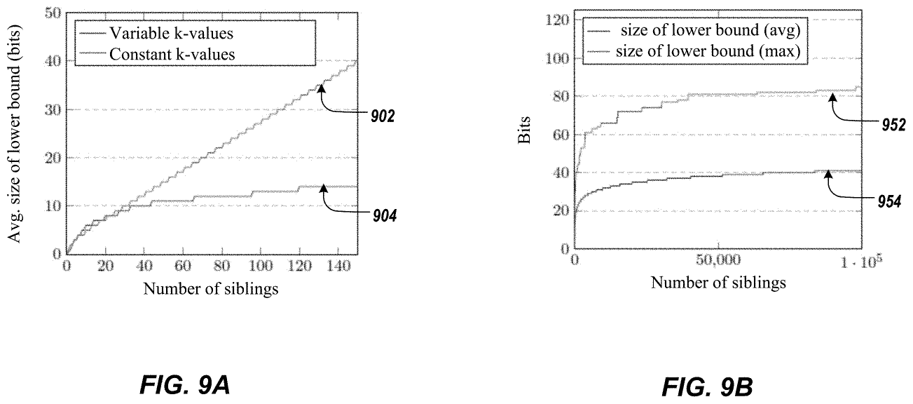

FIGS. 9A and 9B show graphs representing experimental results for encoded labels of an ICON tree. FIG. 9A shows a graph of the average size of encoded labels for the ICON tree with 150 sibling nodes below the root node. The graph illustrates how the the average size of ICON lower bounds grow in bits as the number of sibling nodes added to an ICON tree increases. Sibling nodes were inserted consecutively. The nth sibling was inserted to the right of the n−1st sibling. Line 902 represents label growth as a function of the number of siblings using a constant k-value of 2 and a first node position of 1. Line 904 represents label growth as a function of the number of siblings using the above discussed algorithms for choosing variable k-values and choosing a first node position. The k-value selection algorithm avoids the linear growth of label sizes by increasing the bit count every time an overflow occurs. As a result the labels grow logarithmically with the increasing number of siblings.

FIG. 9B shows a graph of the average and maximum bit size of lower bounds for a tree that consists of 100,000 siblings below the root node. Sibling nodes were inserted in random order. The nth sibling was inserted at a random position to the left of an existing sibling, to the right of an existing sibling or between two existing siblings. C-node k-values were selected based on the k-value selection algorithm discussed above. Line 952 represents the average size of ICON lower bounds and line 954 represents the maximum size of ICON lower bounds as a function of the number of siblings added to the ICON tree.

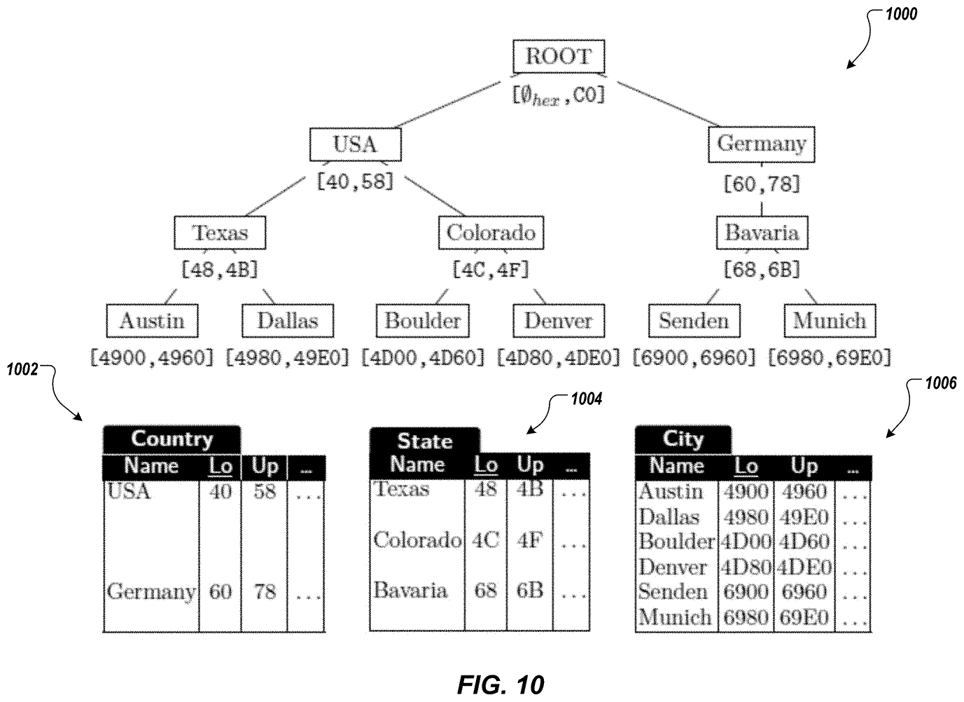

FIG. 10 depicts an example application tree 1000 with ICON lower and upper bounds generated from a corresponding ICON tree (not shown). The labels are encoded in hexadecimal format. The tree 1000 represents example hierarchical database data for a set of countries, states and cities. The lower and upper bounds are indicated below each respective node. In some examples, the lower and upper bounds are stored in association with the payload data of each node. For example, the ICON labels can be stored in computer memory in association with the corresponding data for each node.

In some implementations, relational database tables can be generated from ICON labels of a hierarchical tree 1000 using relational database commands. For example, the following example SQL statements (e.g., using Oracle® Database 12c Release 2 as reference RDBMS) can be used to create a schema with separate tables for countries, states, and cities from the tree 1000. There is no need to create a table for the artificial root node ROOT, since the ICON lower and upper bounds for the root node are constants (Øₕₑₓ and C0). As noted above, the ICON lower and upper bounds can be stored together with each node's data. In some examples, common storage of the ICON bound with the associated data may reduce the number of JOIN statements needed when reading the data. Furthermore, insertions of new nodes may require only a single INSERT statement. Because queries in hierarchical databases process data from the top to the bottom of the hierarchy, in some examples, a data index can be created using only the lower bound column of a relational table.

The following example SQL statements can be used to create the relational database tables 1002, 1004, and 1005 shown in FIG. 10 from the tree 1000 also shown in FIG. 10.

| | |
|---|---|
| 1: | CREATE TABLE COUNTRY( |

| | |
|---|---|
| 2: | name VARCHAR2(256), |
| 3: | lower VARCHAR2(256), |
| 4: | upper VARCHAR2(256) |

| | |
|---|---|
| 5: | ); |
| 6: | CREATE UNIQUE INDEX idx_COUNTRY_lower ON COUNTRY(lower); |
| 7: | |
| 8: | CREATE TABLE STATE( |

| | |
|---|---|
| 9: | name VARCHAR2(256), |
| 10: | lower VARCHAR2(256), |
| 11: | upper VARCHAR2(256) |

| | |
|---|---|
| 12: | ); |
| 13: | CREATE UNIQUE INDEX idx_STATE_lower ON STATE(lower); |
| 14: | |
| 15: | CREATE TABLE CITY( |

| | |
|---|---|
| 16: | name VARCHAR2(256), |
| 17: | lower VARCHAR2(256), |
| 18: | upper VARCHAR2(256) |

| | |
|---|---|
| 19: | ); |
| 20: | CREATE UNIQUE INDEX idx_CITY_lower ON CITY(lower); |

In the example statements above, the alphanumeric column type VARCHAR2(256) can be used for the lower and upper bounds for the sake of readability, however, other column types can be used. The ICON upper and lower bounds can be stored as binary strings or hexadecimal strings. For example, in a production database the upper and lower bound can be stored as binary data using a binary column type.

The following example INSERT statements can be used to populate the tables with data from FIG. 10.

| | |
|---|---|
| 1: | INSERT INTO COUNTRY VALUES(‘USA’, ‘40’, ‘58’); |
| 2: | INSERT INTO STATE VALUES(‘Texas', ‘48’, ‘4B’); |
| 3: | INSERT INTO STATE VALUES(‘Colorado’, ‘4C’, ‘4F’); |
| 4: | INSERT INTO CITY VALUES(‘Austin’, ‘4900’, ‘4960’); |
| 5: | INSERT INTO CITY VALUES(‘Dallas', ‘4980’, ‘49E0’); |
| 6: | INSERT INTO CITY VALUES(‘Boulder’, ‘4D00’, ‘4D60’); |
| 7: | INSERT INTO CITY VALUES(‘Denver’, ‘4D80’, ‘4DE0’); |
| 8: | INSERT INTO COUNTRY VALUES(‘Germany’, ‘60’, ‘78’); |
| 9: | INSERT INTO STATE VALUES(‘Bavaria’, ‘68’, ‘6B’); |
| 10: | INSERT INTO CITY VALUES(‘Senden’, ‘6900’, ‘6960’); |
| 11: | INSERT INTO CITY VALUES(‘Munich’, ‘6980’, ‘69E0’); |

In some examples, sequential traversal across the whole hierarchy can be mapped to a simple UNION that orders all rows by lower bound. The example statements below represent a query that returns all nodes in top-down left-to-right traversal order in accordance with Corollary 1.

| | |
|---|---|
| 1: | SELECT * FROM ( |

| | | |
|---|---|---|
| 2: | (SELECT * FROM COUNTRY) | UNION ALL |
| 3: | (SELECT * FROM STATE ) | UNION ALL |
| 4: | (SELECT * FROM CITY ) | |

| | |
|---|---|
| 5: | ) ORDER BY lower ASC |

Qualified hierarchical queries can be mapped to simple JOIN statements that utilize Corollary 2. For example, the following example statements represent a query that retrieves all cities within the United States.

| | |
|---|---|
| 1: | SELECT t2.name FROM |
| 2: | COUNTRY t1, CITY t2 |
| 3: | WHERE |
| 4: | t1.name=‘USA’ |
| 5: | AND |
| 6: | t2.lower > t1.lower |
| 7: | AND |
| 8: | t2.lower < t1.uppper |

Note that although there is a hierarchical level STATE between COUNTRY and CITY, the query does not reference the STATE table because the query did not express a qualification for states.

In some implementations, a new node can be inserted using a single INSERT statement. For example, the city Waco can be inserted between Austin and Dallas using the following statement.
1: INSERT INTO CITY VALUES(‘Waco’, ‘4968’, ‘496B’)

A computing system can determine the lower and upper bounds for the new city “Waco” by decoding the hexadecimal lower bounds for “Austin” and “Dallas” respectively. For example, decoding 4900ₕₑₓ (Austin) yields C.0.C.0.C.0 and decoding 4980ₕₑₓ (Dallas) yields C.0.C.0.C.1. ICON bounds for inserting Waco between Austin and Dallas can be determined using the InsertInBetween function described above (e.g., InsertInBetween(C.0.C.0.C.0, C.0.C.0.C.1)) to yield C.0.C.0.C.0.S.C.0 as the ICON label for Waco. Waco's ICON label can be converted to a lower and upper bound in hexadecimal format according the processes described above to yield 4968ₕₑₓ and 496Bₕₑₓ.

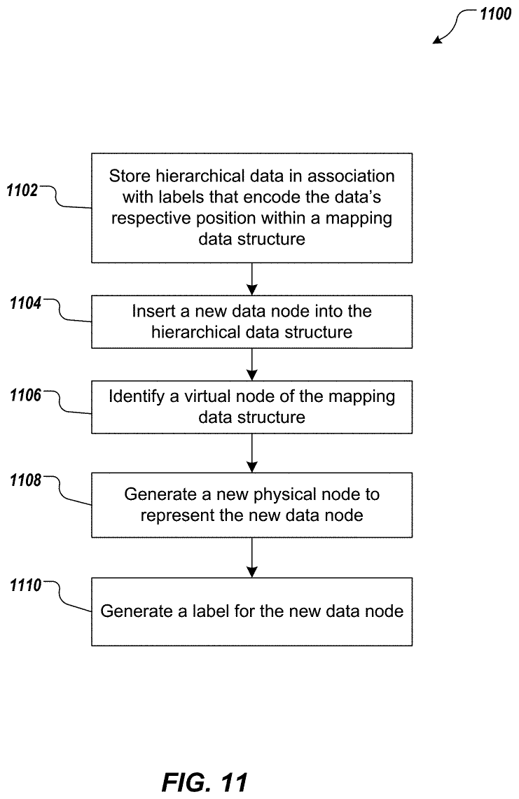

FIG. 11 is a flowchart illustrating an example process 1100 that can be executed in accordance with implementations of the present disclosure. In some implementations, the process 1100 can be realized using one or more computer-executable programs that are executed using one or more computing devices. For example, the process 1100 can be executed by one or more computing systems including, but not limited to, a database server, application server, server system, laptop computer, desktop computer, tablet computer, or smartphone. In some examples, some steps of the process 1100 may be performed by one computing system and other steps may be performed by another computing system.

A computing system stores data from a hierarchical data structure in association with labels that encode the data's respective position within a mapping data structure (1102). For example, the mapping data structure maps hierarchically structured information into relationally structured data. The mapping data structure can be an ICON tree that includes physical nodes and virtual nodes. The physical nodes can represent data nodes of the hierarchical data structure. The virtual nodes can represent a type of hierarchical relationship between corresponding physical nodes. Each virtual node can serve as an expansion node (e.g., a hook) that permits the addition and deletion of data within the hierarchical structure without altering labels associated with other data nodes. For example, a hierarchical data structure can be an application tree.

The computing system inserts a new data node into the hierarchical data structure (1104). The server may receive an indication that specifies a position of the new data within the hierarchical data structure. For example, the server can receive new data to be inserted into the hierarchical data structure as a sibling of an existing data node, as a child of an existing data node, or between two existing data nodes. The server can receive an indication that the new data node is to be inserted to the left or right of an existing data node. The computing system can insert the new data node by performing process steps 1106-1110.

The computing system identifies a virtual node of the mapping data structure (1106). For example, the server identifies a virtual node that represents a location in the hierarchical data structure in which the new data node is to be inserted. For example, the identified virtual node can represent a type of relationship between the new data node and an existing data node. In some implementations, the virtual node can be designated as R-node, L-node, S-node, or C-node.

The computing system generates a new physical node to represent the new data node (1108). For example, the new physical node can be linked to the identified virtual node within the data structure. The computing system generates a label for the new data node (1110). For example, the server can generate the label for the new data node based, in part, on a type of the virtual node. In some implementations, the label for the new data node encodes a path from a root of the mapping data structure to the new data node. The label can be encoded in a binary or hexadecimal format, for example.

In some implementations, if the new data node is to be inserted to the left of an existing sibling node the server identifies a leftmost sibling node of the new data node. For example, the server can identify a leftmost sibling node based on a node label. The server determines whether the leftmost sibling node is located in a leftmost physical node position. For example, the server can determine if the leftmost sibling node is at the first position of a C-node array (e.g., the leftmost sibling is in position 0). If the leftmost sibling node is not located in a leftmost physical node position, then the server can assign the new data node to a new physical node position to the left of the leftmost node. If the leftmost sibling node is located in a leftmost physical node position, then the server can generate a new virtual node sub-tree (e.g., a new sub-tree from an L-node as described above), and assign the new data node as the first physical node descendant of the new sub-tree.

In some implementations, if the new data node is to be inserted to the right of an existing sibling node the server identifies a rightmost sibling node of the new data node. For example, the server can identify the rightmost sibling node based on a node label. The server determines whether the rightmost sibling node is located in a rightmost physical node position. For example, the server can determine whether the rightmost sibling node is at the end of a C-node array (e.g., the rightmost sibling is in a physical node position equal to 2^{k}−1). If the rightmost sibling node is not located in a rightmost physical node position, then the server can assign the new data node to a new physical node position to the right of the rightmost node. If the rightmost sibling node is located in a rightmost physical node position, then the server can generate a new virtual node sub-tree (e.g., a new sub-tree from an R-node as described above), and assign the new data node as the first physical node descendant of the new sub-tree.

In some implementations, if the new data node is to be inserted between two existing sibling nodes the server identifies two existing nodes to insert the new data node between. For example, the server can identify left and right bounding nodes. The server determines whether the new data node can be inserted to either the right or the left of one of the two bounding nodes based on the labels of the two existing nodes. For example, as described above, the server can perform comparisons between node labels. For example, the server can perform a comparison between node labels of the right bounding node and a new position to the right of the left bounding node. As another example, the server can perform a comparison between node labels of the left bounding node and a position to the left of the right bounding node. If the new data node can be inserted to either the right or the left of one of the two bounding nodes, then the server can assign the new data node to a new physical node position to the right of the left bounding node or to the left of the right bounding node as applicable. If the new data node cannot be inserted to either the right or the left of one of the two bounding nodes, then the server can generate a new virtual node sub-tree (e.g., a new sub-tree from an S-node as described above), and assign the new data node as the first physical node descendant of the new sub-tree.

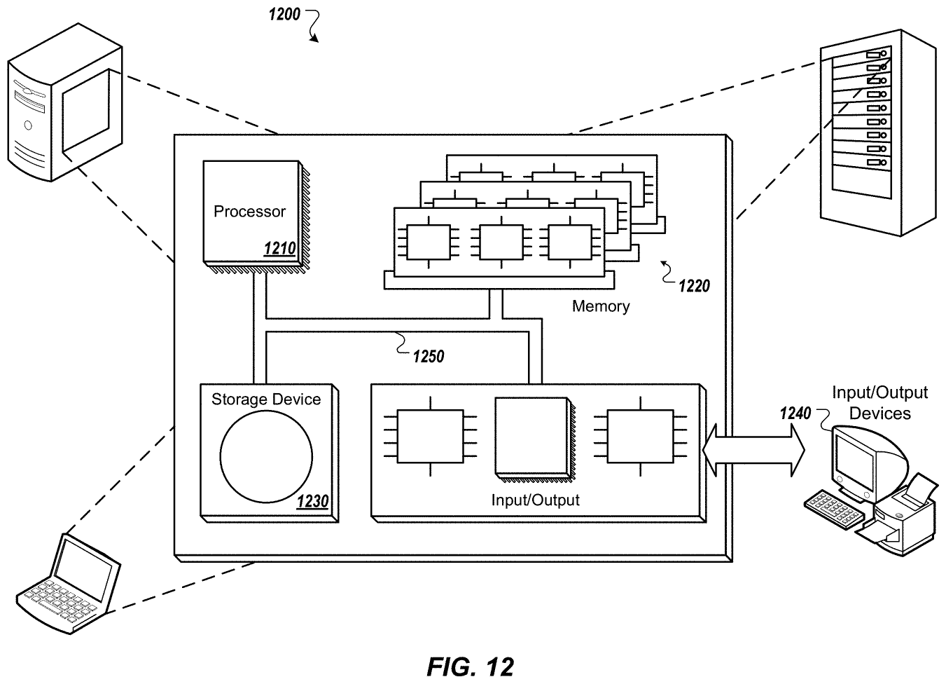

FIG. 12 is a schematic illustration of example computer systems 1200 that can be used to execute implementations of the present disclosure. The system 1200 can be used for the operations described in association with the implementations described herein. For example, the system 1200 may be included in any or all of the server components discussed herein. The system 1200 includes a processor 1210, a memory 1220, a storage device 1230, and an input/output device 1240. Each of the components 1210, 1220, 1230, 1240 is interconnected using a system bus 1250. The processor 1210 is capable of processing instructions for execution within the system 1200. In one implementation, the processor 1210 is a single-threaded processor. In another implementation, the processor 1210 is a multi-threaded processor. The processor 1210 is capable of processing instructions stored in the memory 1220 or on the storage device 1230 to display graphical information for a user interface on the input/output device 1240.

The memory 1220 stores information within the system 1200. In one implementation, the memory 1220 is a computer-readable medium. In one implementation, the memory 1220 is a volatile memory unit. In another implementation, the memory 1220 is a non-volatile memory unit. The storage device 1230 is capable of providing mass storage for the system 1200. In one implementation, the storage device 1230 is a computer-readable medium. In various different implementations, the storage device 1230 may be a floppy disk device, a hard disk device, an optical disk device, a solid-state memory device, or a tape device. The input/output device 1240 provides input/output operations for the system 1200. In one implementation, the input/output device 1240 includes a keyboard and/or pointing device. In another implementation, the input/output device 1240 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described.

Nevertheless, it will be understood that various modifications may be made without departing from the spirit and scope of the present disclosure. Accordingly, other implementations are within the scope of the following claims.

What is claimed is:

1. A method for storing and retrieving data in a computer memory system, the method being executed by one or more processors and comprising:
storing, by the one or more processors, data from a hierarchical structure with labels that encode the data's respective position within a data structure that maps hierarchically structured information into relationally structured data, the data structure comprising:
physical nodes, each physical node representing a data node of the hierarchical structure, and
virtual nodes, each virtual node representing a type of hierarchical relationship between corresponding physical nodes, and wherein each virtual node serves as an expansion node that permits addition and deletion of data within the hierarchical structure without altering labels associated with existing data.

2. The method of claim 1, further comprising inserting a new data node into the hierarchical structure by:
identifying a virtual node that represents a location in the hierarchical structure in which the new data node is to be inserted,
generating a new physical node to represent the new data node, the new physical node linked to the identified virtual node within the data structure, and
generating a label for the new data node based, in part, on a type of the virtual node.

3. The method of claim 1, wherein a label for each node of the data structure encodes a path from a root node to the node's position within the data structure by representing each physical node along the path by an integer value and by representing each virtual node along the path by a coded value indicative of a type of each respective virtual node.

4. The method of claim 3, wherein identities of successive nodes along the path are concatenated together to provide the label.

5. The method of claim 4, wherein virtual node identities are represented by 2-bit codes that indicate the type of a respective virtual node.

6. The method of claim 3, wherein physical node identities are represented by integer values ranging from 0 to 2^{k}−1, where k is a positive integer.

7. The method of claim 6, wherein a first value of k for physical nodes in a first portion of the data structure is different from a second value of k for physical nodes in a second portion of the data structure.

8. The method of claim 6, further comprising determining a value of k for a certain physical node based on scanning components of a label of the certain physical node.

9. The method of claim 2, wherein identifying the virtual node comprises:
identifying a leftmost sibling node of the new data node; and
determining that the leftmost sibling node is not located in a leftmost physical node position,
wherein generating the new physical node to represent the new data node comprises assigning the new data node to a new physical node position that is left of the leftmost sibling node.

10. The method of claim 2,
wherein identifying the virtual node comprises:
identifying a leftmost sibling node of the new data node; and
determining that the leftmost sibling node is located in a leftmost physical node position,
wherein generating the new physical node to represent the new data node comprises:
generating a new virtual node sub-tree; and
assigning the new data node as a first physical node descendant of the new virtual node sub-tree.

11. The method of claim 10, wherein a type of a virtual node of the new virtual node sub-tree indicates a leftward expansion of the data structure.

12. The method of claim 2, wherein identifying the virtual node comprises:
identifying a rightmost sibling node of the new data node; and
determining that the rightmost sibling node is not located in a rightmost physical node position,
wherein generating the new physical node to represent the new data node comprises assigning the new data node to a new physical node position that is right of the rightmost sibling node.

13. The method of claim 2,
wherein identifying the virtual node comprises:
identifying a rightmost sibling node of the new data node; and
determining that the rightmost sibling node is located in a rightmost physical node position,
wherein generating the new physical node to represent the new data node comprises:
generating a new virtual node sub-tree; and
assigning the new data node as a first physical node descendant of the new virtual node sub-tree.

14. The method of claim 13, wherein a type of a virtual node of the new virtual node sub-tree indicates a rightward expansion of the data structure.

15. The method of claim 2, wherein identifying the virtual node comprises:
identifying two existing nodes to insert the new data node between; and
determining, based on the labels of the two existing nodes, that the new data node can be inserted in either a position that is right or a position that is left of one of the two existing nodes,
wherein generating the new physical node to represent the new data node comprises assigning the new data node to the position that is right or to the position that is left of the one of the two existing nodes.

16. The method of claim 2,
wherein identifying the virtual node comprises:
identifying two existing nodes to insert the new data node between; and
determining, based on the labels of the two existing nodes, that the new data node cannot be inserted to either a position that is right or a position that is left of one of the two existing nodes,
wherein generating the new physical node to represent the new data node comprises:
generating a new virtual node sub-tree; and
assigning the new data node as a first physical node descendant of the new virtual node sub-tree.

17. The method of claim 1, wherein node labels of the data structure are structured in an order representing a top-to-bottom, left-to-right traversal of the data structure.

18. A system comprising:
at least one processor; and a data store coupled to the at least one processor having instructions stored thereon which, when executed by the at least one processor, causes the at least one processor to perform operations comprising:
storing data from a hierarchical structure with labels that encode the data's respective position within a data structure that maps hierarchically structured information into relationally structured data, the data structure comprising:
physical nodes, each physical node representing a data node of the hierarchical structure, and
virtual nodes, each virtual node representing a type of hierarchical relationship between corresponding physical nodes, and wherein each virtual node serves as an expansion node that permits addition and deletion of data within the hierarchical structure without altering labels associated with existing data.

19. The system of claim 18, wherein the operations further comprise inserting a new data node into the hierarchical structure by:
identifying a virtual node that represents a location in the hierarchical structure in which the new data node is to be inserted,
generating a new physical node to represent the new data node, the new physical node linked to the identified virtual node within the data structure, and
generating a label for the new data node based, in part, on a type of the virtual node.

20. The system of claim 19,
wherein identifying the virtual node comprises:
identifying a leftmost sibling node of the new data node; and
determining that the leftmost sibling node is located in a leftmost physical node position, and
wherein generating the new physical node to represent the new data node comprises:
generating a new virtual node sub-tree; and
assigning the new data node as a first physical node descendant of the new virtual node sub-tree.

21. The system of claim 19,
wherein identifying the virtual node comprises:
identifying a rightmost sibling node of the new data node; and
determining that the rightmost sibling node is located in a rightmost physical node position, and
wherein generating the new physical node to represent the new data node comprises:
generating a new virtual node sub-tree; and
assigning the new data node as a first physical node descendant of the new virtual node sub-tree.

22. The system of claim 19,
wherein identifying the virtual node comprises:
identifying two existing nodes to insert the new data node between; and
determining, based on the labels of the two existing nodes, that the new data node cannot be inserted to either a position that is right or a position that is left of one of the two existing nodes, and
wherein generating the new physical node to represent the new data node comprises:
generating a new virtual node sub-tree; and
assigning the new data node as a first physical node descendant of the new virtual node sub-tree.

23. A non-transitory computer readable storage medium storing instructions that, when executed by at least one processor, cause the at least one processor to perform operations comprising:
storing data from a hierarchical structure with labels that encode the data's respective position within a data structure that maps hierarchically structured information into relationally structured data, the data structure comprising:
physical nodes, each physical node representing a data node of the hierarchical structure, and
virtual nodes, each virtual node representing a type of hierarchical relationship between corresponding physical nodes, and wherein each virtual node serves as an expansion node that permits addition and deletion of data within the hierarchical structure without altering labels associated with existing data.

24. The medium of claim 23, wherein the operations further comprise inserting a new data node into the hierarchical structure by:
identifying a virtual node that represents a location in the hierarchical structure in which the new data node is to be inserted,
generating a new physical node to represent the new data node, the new physical node linked to the identified virtual node within the data structure, and
generating a label for the new data node based, in part, on a type of the virtual node.

25. The medium of claim 24,
wherein identifying the virtual node comprises:
identifying a leftmost sibling node of the new data node; and
determining that the leftmost sibling node is located in a leftmost physical node position, and
wherein generating the new physical node to represent the new data node comprises:
generating a new virtual node sub-tree; and
assigning the new data node as a first physical node descendant of the new virtual node sub-tree.

26. The medium of claim 24,
wherein identifying the virtual node comprises:
identifying a rightmost sibling node of the new data node; and
determining that the rightmost sibling node is located in a rightmost physical node position, and
wherein generating the new physical node to represent the new data node comprises:
generating a new virtual node sub-tree; and
assigning the new data node as a first physical node descendant of the new virtual node sub-tree.

27. The medium of claim 24,
wherein identifying the virtual node comprises:
identifying two existing nodes to insert the new data node between; and
determining, based on the labels of the two existing nodes, that the new data node cannot be inserted to either a position that is right or a position that is left of one of the two existing nodes, and
wherein generating the new physical node to represent the new data node comprises:
generating a new virtual node sub-tree; and
assigning the new data node as a first physical node descendant of the new virtual node sub-tree.
